(19) United States
(12) Patent Application Publication
(10) Pub. No.: US 2007/0067323 A1
(43) Pub. Date: Mar. 22, 2007

(54) Fast file shredder system and method

(75) Inventor: Kirstan Anderson Vandersluis, Colorado Springs, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Kirstan Anderson Vandersluis

(21) Appl. No.: 11/524,224

(22) Filed: Sep. 20, 2006

Related U.S. Application Data
(60) Provisional application No. 60/718,809, filed on Sep. 20, 2005.

(51) Int. Cl. G06F 7/00

(52) U.S. Cl. 707/100

(57) ABSTRACT

A fast file shredder system has a state machine that converts a large XML file into a number of flat files. The state machine uses a serial access parser that parses the XML and places the appropriate parts of the XML file data into one of several flat files. When the state machine encounters a trigger element in the XML file, the state machine transitions to another state and starts writing portions of the XML file data into another of the flat files.

### RELATED APPLICATIONS

The present invention claims priority on provisional patent application Ser. No. 60/718,809, filed on Sep. 20, 2005, entitled “Fast File Shredder, Decomposing Large XML Files into Database-Loadable Files” and is hereby incorporated by reference.

### FIELD OF THE INVENTION

The present invention relates generally to the field of computer databases and more particularly to a fast file shredder system and method.

### BACKGROUND OF THE INVENTION

While large corporations support many different data sources and data formats, RDBMSs (Relational DataBase Management Systems) continue to be relied on for many mission-critical data. At the same time, the growth of XML standards has led companies to frequently use XML to move information from one computer system to another. As a result, many information exchange applications require the processing of large XML files into a database. Database vendors have addressed the need for loading large amounts of data using bulk load utilities. These bulk load utilities require that the input data be in flat file format, such as a comma delimited file. When the XML format is complex, a single XML file must be split into many flat files, each to be imported into a different database table. Unfortunately, there are not any adequate tools that efficiently convert large XML files into the required multiple flat files.

Thus, there exists a need for a fast file shredder system and method that efficiently converts large XML files into flat files for loading into databases.

### SUMMARY OF INVENTION

A fast file shredder system that overcomes these and other problems has a state machine that converts a large XML file into a number of flat files. The state machine uses a serial access parser that parses the XML and places the appropriate parts of the XML file data into one of several flat files. When the state machine encounters a trigger element in the XML file, the state machine transitions to another state and starts writing portions of the XML file data into another of the flat files. The flat files have a means to distinguish between the various records in the file. A wizard allows the user to easily create the state machine. A sample XML instance or XML Schema is used in conjunction with the wizard to define the states of the state machine and the transition triggers. This system allows users to easily and quickly create a state machine for creating flat files that can be used by database bulk load utilities.

### BRIEF DESCRIPTION OF THE DRAWINGS

FIG. 1 is a block diagram of a fast file shredder system in accordance with one embodiment of the invention;

FIG. 2 is a block diagram of a fast file shredder system in accordance with one embodiment of the invention;

FIG. 3 is a flow chart of the steps used in a fast file shredder method in accordance with one embodiment of the invention;

FIG. 4 is an example of an XML file in accordance with one embodiment of the invention;

FIG. 5 is schematic diagram of a state machine in accordance with one embodiment of the invention;

FIG. 6 is an example of an output flat file in accordance with one embodiment of the invention;

FIG. 7 is an example of an output flat file in accordance with one embodiment of the invention;

FIG. 8 is a screen shot of a wizard input parameter screen in accordance with one embodiment of the invention;

FIG. 9 is a screen shot of a wizard write file screen in accordance with one embodiment of the invention;

FIG. 10 is a screen shot of a wizard file/XML mapper screen in accordance with one embodiment of the invention;

FIG. 11 is a screen shot of a wizard path screen in accordance with one embodiment of the invention; and

FIG. 12 is a screen shot of a wizard component reference screen in accordance with one embodiment of the invention.

### DETAILED DESCRIPTION OF THE DRAWINGS

The present invention is directed to fast file shredder system that allows a user to easily, quickly and inexpensively convert a large input XML file into a number of flat files for use with a bulk load utility of a database. The fast file shredder system has a state machine with a number of different states. The state machine uses a serial access parser that parses the XML and places the appropriate parts of the XML file data into one of several flat files. When the state machine encounters a trigger element in the XML file, the state machine transitions to another state and starts writing portions of the XML file data into another of the flat files. The flat files have a means to distinguish between the various records. A wizard allows the user to easily create the state machine. A sample XML instance is used in conjunction with the wizard to define the states of the state machine and the transition triggers. This system allows users to easily and quickly create a state machine for creating flat files that can be used by database bulk load utilities.

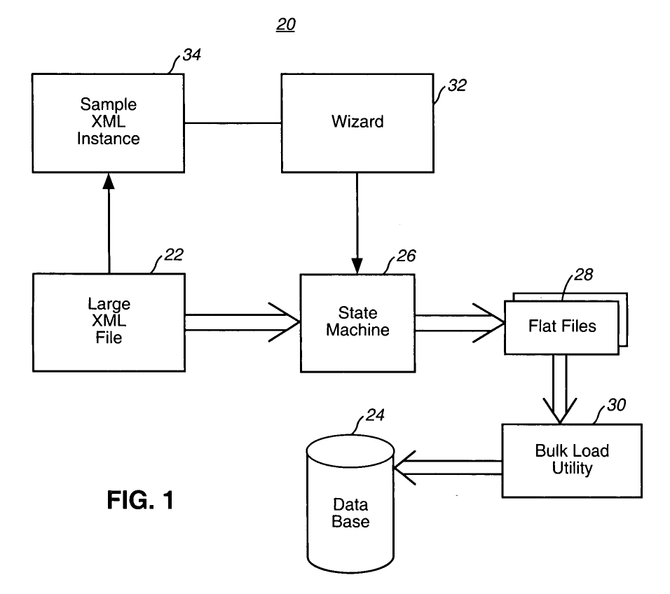

FIG. 1 is a block diagram of a fast file shredder system 20 in accordance with one embodiment of the invention. The system 20 is designed to allow large XML files 22 to be easily loaded into a database 24. A state machine 26 acts on the XML file 22 and produces a number of flat files 28. The flat files 28 are processed by a bulk loading utility 30 to enter the XML data into the database 24. The system 20 has a wizard 32 that walks the user through the process of creating the state machine 26. The wizard 32 uses a sample XML instance (or XML Schema) 34 to create the state machine.

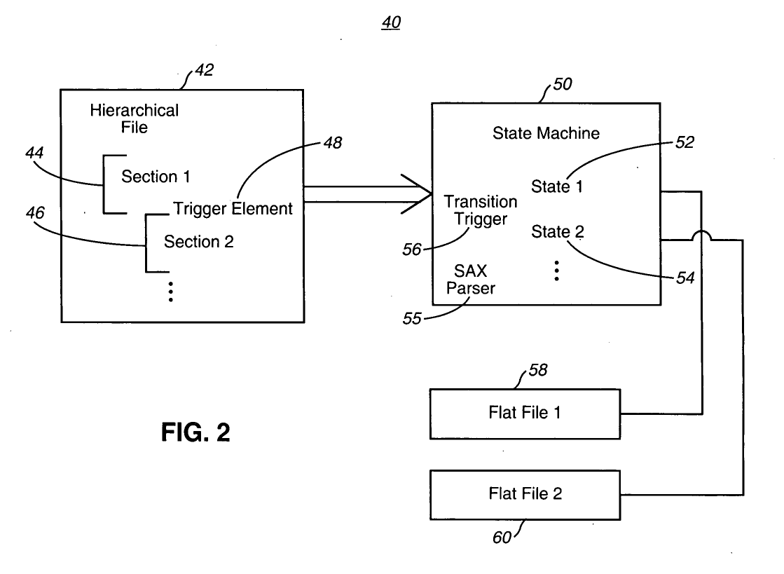

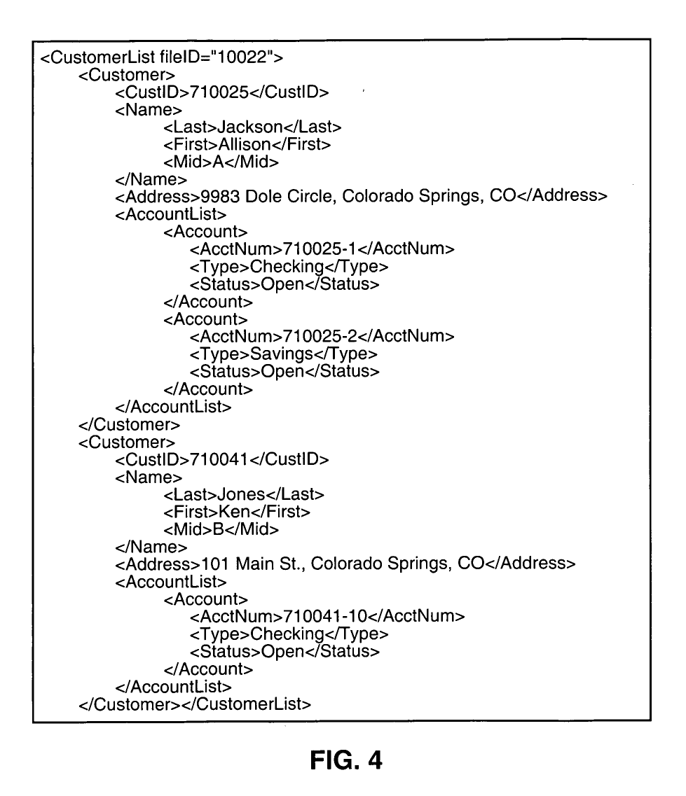

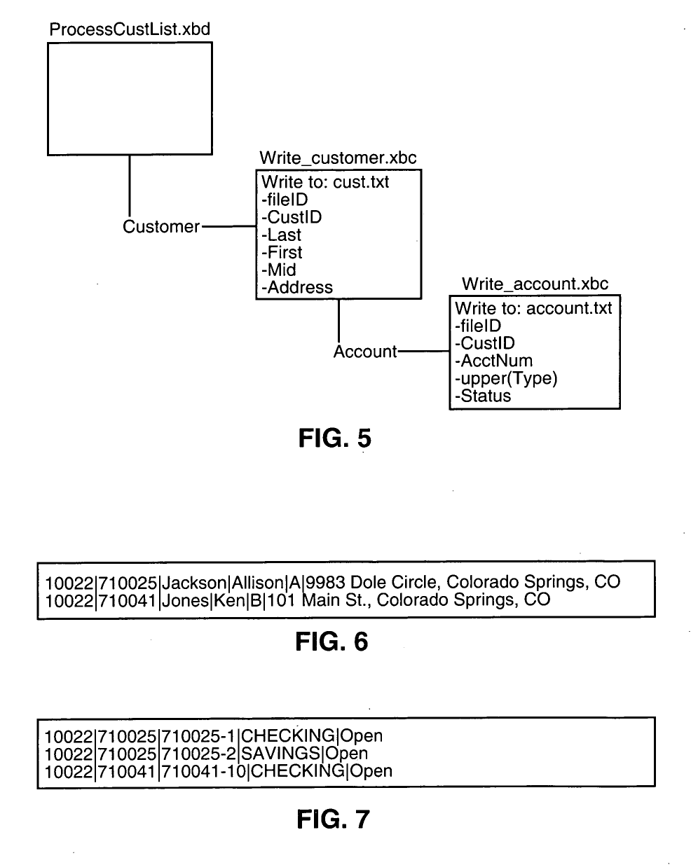

FIG. 2 is a block diagram of a fast file shredder system 40 in accordance with one embodiment of the invention. The system 40 has an input hierarchical file 42, which may be an XML file. The hierarchical file 42 has a number of sections 44, 46 that define different types of records. A trigger element 48 in the hierarchical file indicates a transition between a first section and a second section. A state machine 50 processes the input hierarchical file 42. The state machine 50 has a number of states 52, 54. The state machine uses a SAX (Simple API for XML) parser 55 to process the XML file in a high speed, serial fashion. Transition triggers 56 are invoked when the SAX parser encounters a particular element in the input file, and causes the state machine to switch another state. When the SAX parser 55 encounters the end tag of the element that caused the transition trigger, the state machine reverts to the previous state. States can be nested to an arbitrary number of levels. The first state 52 writes records to a first flat file 58. Note that the flat records are commonly delimited files, such as comma delimited files. The second state 54 writes records to a second flat file 60. An example of the XML file is shown in FIG. 4 and examples of the flat files are shown in FIGS. 5 & 6.

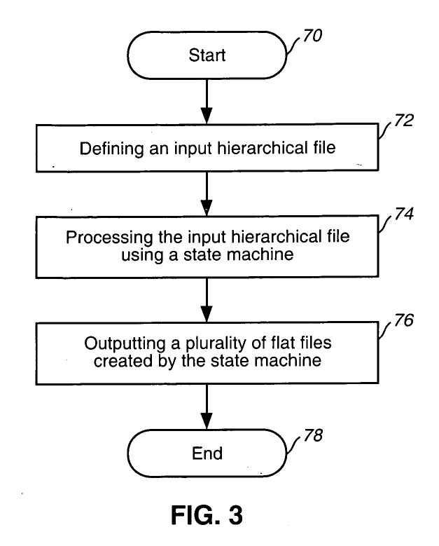

FIG. 3 is a flow chart of the steps used in a fast file shredder method in accordance with one embodiment of the invention. The process starts, step 70, by defining an input hierarchical file at step 72. The input hierarchical file is processed using a state machine at step 74. At step 76a plurality of flat files are created by the state machine which ends the process at step 78.

The following section will describe the wizard used to convert a large XML file into a number of flat files. Some of the terminology is specific to the wizard application. The Fast File Shredder system produces high-speed results by parsing files using a Simple API (application program interface) for XML (SAX) parser, which is a serial access parser. XA-Designer (Wizard) lets the user produce a mapping of multiple XML sections within the file to multiple output flat file formats, using visual drag and drop mapping operations within the FileBizComponent wizard. The mappings and their relationships are stored in files called BizFiles. Types of BizFiles include BizDocument and FileBizComponents.

The BizFiles (BizDocument and FileBizComponents) and their relationships define a state machine used by the system to dictate processing instructions to the system. Transitions from one state to another are dictated by the calling structure within the BizFiles. Each BizFile represents a state within the processor, and indicates key information for processing, such as what file is being written, the elements that are included in the output, and the transformations are applied to each field.

As an example, consider the following XML instance representing banking information that needs to be imported into a database shown in FIG. 4. The format supports any number of Customer elements, and each Customer element can contain any number of Account elements. To enable fast processing of large XML files of this format into a database, we design a BizDocument and 2 FileBizComponents. Conceptually, these BizFiles are related as shown in FIG. 5.

The lines between boxes represent the transitions between states. Each is labeled with the name of the inbound element which causes a state transition. For example, the processor starts in the state “ProcessCustList.xbd” and begins the process of SAX parsing the file. When the SAX parser encounters the start tag of the element “Customer” in the inbound XML stream (“<Customer>” in FIG. 4), the processor transitions to state “write_customer.xbc”. This state is defined by a FileBizComponent of the same name, and contains information on the file to write to, the elements and attributes to write, and how to distinguish fields. When the SAX parser encounters the end tag of the element “Customer” (“</Customer>” in FIG. 4), the processor writes a record to the specified file and returns to the previous state. The record includes the accumulated data obtained while the processor is in that state.

The processor will transition between states either by finding the end tag of the state transition element (“</Customer>” in this case), or by encountering a new state transition element (trigger). In the current example, the processor encounters the element “Account”, at which time it transitions to the state write_account.xbc. The processor begins processing in accordance with the new state as defined by its FileBizComponent. Here, the processor obtains the data from the inbound XML (FIG. 4) between an Account start tag (“<Account>”) and an Account end tag (“</Account>”), ultimately writing a record to file account.txt.

Note that in the Write_account.xbc state, one of the fields undergoes transformation with a call to a functoid, “lower()”, which converts the text to lower case prior to writing out the record.

The results of running the Fast File Shredder system on the sample input shown in FIG. 4 include the output files defined by the two FileBizComponents. These output files are shown in FIGS. 6 & 7. As is shown in FIG. 6, the Customer data is converted to flat records whose fields are separated by the bar character ‘|’. The Account data, FIG. 7. is also converted to flat records whose fields are separated by the bar character ‘|’. Notice also that elements and attributes higher up in the hierarchy, such as the fileID attribute ‘10022’ is also included in the output. Any data already read by the SAX parser is available at any time. Note also that various forms of field and record delineation (delimited, fixed length) are supported.

The BizFiles (State Machine) are created in XA-Designer (Wizard) using normal XAware design processes. The user begins with a sample XML instance or XML Schema in the desired format, then converts appropriate sections of the XML format into FileBizComponents.

Each section of the XML format that needs to be written to a file must be converted to a FileBizComponent (State). The user should begin with sections deep in the hierarchy, then move to sections progressively higher in the hierarchy. To convert a section, select the element that best matches the granularity of the record to be written to the file. For example, to convert the Account information, we can consider selecting either the AccountList element, or the Account element. Since the Account element is the repeating structure that will lead to a record in the output file, it is that element, rather than the AccountList element which should be selected.

XA-Designer includes a wizard that creates the mapping of the XML to the appropriate flat file format. Select the Account element, then right-click the option, “Make New BizComponent”. Select the “File BizComponent” option from the list. XA-Designer presents a wizard which captures the information necessary to convert the Account element into a FileBizComponent.

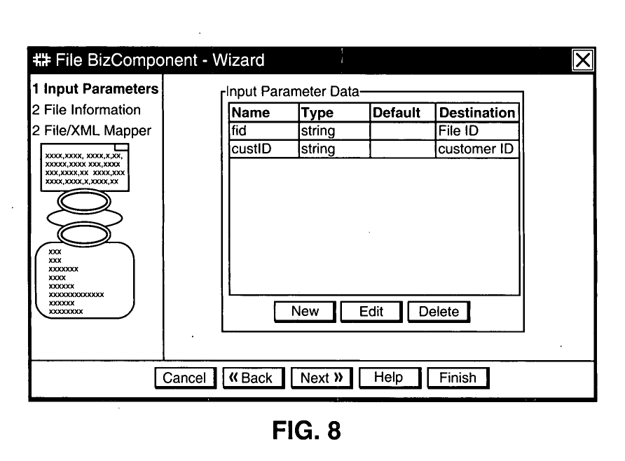

The first wizard screen, FIG. 8, is the input parameter screen. Here, we can define a number of parameters to send into the BizComponent. In our example, we want to store two data elements that appear at a higher level in the XML hierarchy. These elements are the fileID and the CustID fields. To make them available to the FileBizComponent, we define each as an input parameter. Notice that the parameter name does not have to be the same as the element or attribute name in the inbound XML.

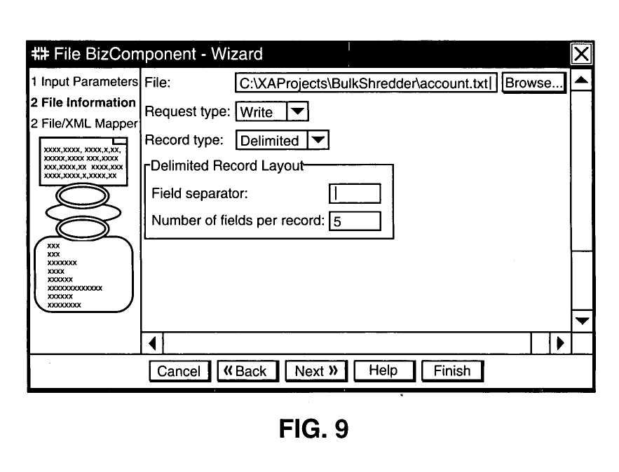

After clicking Next, the wizard prompts for options for the File BizComponent. Enter a target file to write to, and specify the options as shown in FIG. 9.

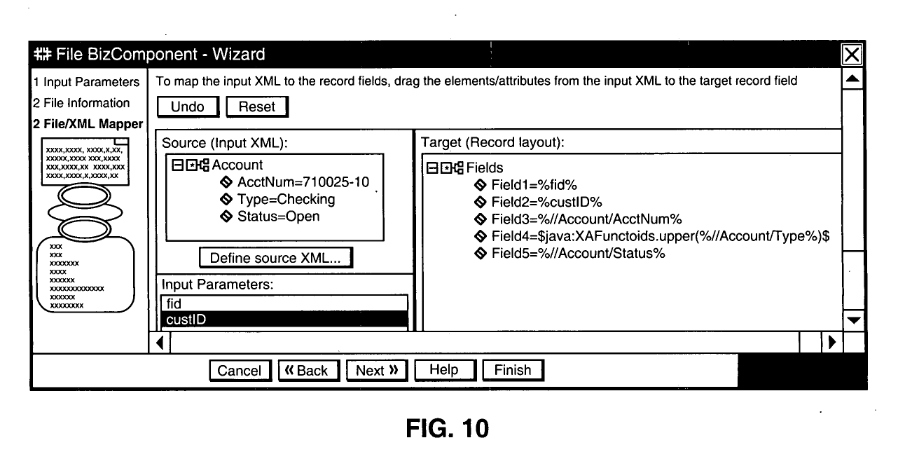

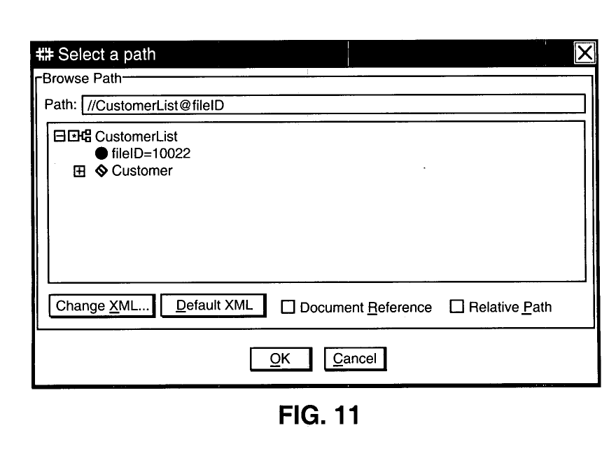

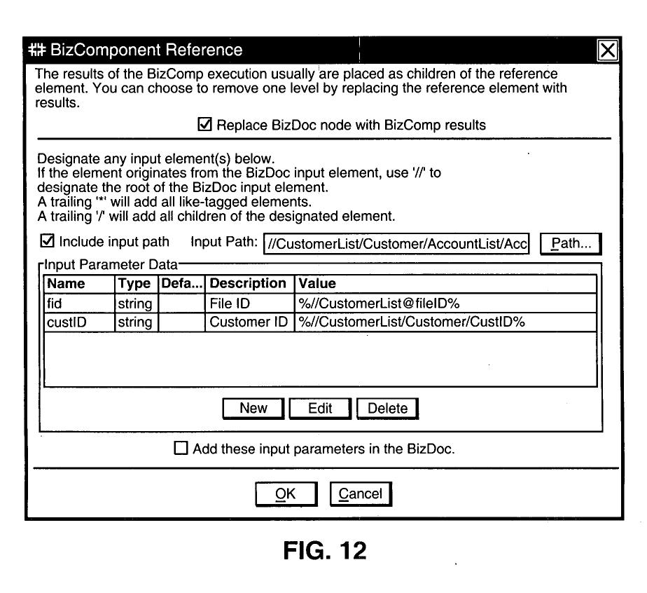

The next wizard screen, FIG. 10, lets you map the XML format and input parameters to the flat record format, and apply functoids as necessary. After clicking finish, you are prompted to save the new File BizComponent, then supply any input information to designate how the BizDocument will call the new component. On the BizComponent Reference window, ensure that “Include input path” is checked. For each of the input parameters, double-click the parameter name, and fill in a value using the Path . . . button, which brings up the window shown in FIG. 11. You should select the appropriate path in the input element for each. The BizComponent Reference window should look similar to that shown in FIG. 12.

After clicking OK, the original BizDocument is modified so that the Account element and all its children are replaced by a reference to the new File BizComponent. At this point, the AccountList element should be moved so that it is after the Customer element, rather than a child of that element. This will ensure that you don't inadvertently lose the reference when converting the Customer element to a FileBizComponent, which is the next step.

After moving the AccountList element as described above, convert the Customer element to a file BizComponent in a similar manner. After you have done this, you are ready to make final preparations for execution, described in the next section.

The calling structure of the BizFiles should reflect the hierarchical relationship of the original XML format. This means the BizDocument should call the FileBizComponent that converts the highest level section in the hierarchy. In our sample, the highest level section is “Customer”, so the BizDocument should call write_customer.xbc. Lower level sections are processed by a FileBizComponent calling the lower level FileBizComponent in a xa:merge_template element. See write_customer.xbc below for an example of this.

Applications sometimes require validation of a record prior to outputting the record to a file. This capability is provided by specifying a functoid on the FileBizComponent's xa:request element. The validation functoid is specified using the xa:validator=“<functoid call>”. The functoid must be a static method defined to take a single String input parameter, and return a String value. At run time, prior to writing the string record to the output file, the processor calls the functoid, passing the string record as the single parameter into the functoid. The functoid communicates back to the processor with the return string. If the return string is zero-length, no record is written to the output file. If the return string has positive length, it is written to the file. If an exception is thrown by the functoid, parsing of the input file stops, returning the error message to the BizDocument processor, which can be included in the BizDocuments results using the $xavar:error$ variable. You have defined a state machine that is capable of quickly, converting an XML file style into flat files that can be used by a bulk load utility to enter the data into a database.

Thus there has been described a fast file shredder system that allows a user to easily, quickly and inexpensively convert a large input XML file into a number of flat files for use with a bulk load utility of a database.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A fast file shredder system, comprising:
an input hierarchical file having a plurality of sections;
a state machine having a plurality of states, one of the plurality of states for each of the plurality of sections of the input hierarchical file; and
a plurality of output flat files created by the state machine.

2. The system of claim 1, wherein the state machine has a transition trigger that causes the state machine to transition from one of the plurality of states to a second of the plurality of states.

3. The system of claim 2, wherein the transition trigger has a trigger definition that defines a trigger element.

4. The system of claim 3, wherein the input hierarchical file includes the trigger element.

5. The system of claim 1, further including a wizard for defining the state machine.

6. The system of claim 5, wherein the wizard defines a trigger element.

7. A fast file shredding method, comprising the steps of:
a) defining an input hierarchical file;
b) processing the input hierarchical file using a state machine; and
c) outputting a plurality of flat files created by the state machine.

8. The method of claim 7, wherein step (a) further including the step of:
a1) specifying an XML file.

9. The method of claim 7, wherein step (b) further includes the steps of:
b1) creating a sample XML instance of the input hierarchical file;
b2) creating the state machine using a wizard.

10. The method of claim 9, wherein step (b2) further includes the step of:
defining a transition trigger.

11. The method of claim 7, wherein step (b) further includes the step of:
b1) parsing the input hierarchical file using a serial access parser.

12. The method of claim 11, further including the steps of:
b2) defining a record delimiter.

13. A fast file shredder system, comprising:
an input XML file having two sections;
a state machine having two states, each of the two states corresponding to the two sections of the input XML file; and
a pair of output flat files created by the state machine.

14. The system of claim 13, wherein the state machine includes a serial access parser.

15. The system of claim 14, further including a wizard for defining the state machine.

16. The system of claim 15, further including a sample XML instance called by the wizard.

17. The system of claim 14, wherein the state machine has a transition trigger that causes the state machine to transition from one of the plurality of states to a second of the plurality of states.

18. The system of claim 17, wherein the transition trigger has a trigger definition that defines a trigger element.

19. The system of claim 18, wherein the input hierarchical file includes the trigger element.
